(19) United States
(12) Patent Application Publication
(10) Pub. No.: US 2012/0177182 A1
(43) Pub. Date: Jul. 12, 2012

(54) OBJECT IMAGING SYSTEM AND X-RAY DIFFRACTION IMAGING DEVICE FOR A SECURITY SYSTEM

(76) Inventors: Stephan Olesinski, Hamburg (DE); Geoffrey Harding, Hamburg (DE); Dirk Kosciesza, Pinneberg (DE); Helmut Strecker, Hamburg (DE)

(21) Appl. No.: 13/004,982

(22) Filed: Jan. 12, 2011

(51) Int. Cl. G01N 23/201

(52) U.S. Cl. 378/87

(57) ABSTRACT

An x-ray diffraction imaging (XDI) device includes at least one x-ray source configured to emit an x-ray fan-beam. The XDI device also includes a primary collimator positioned downstream of the at least one x-ray source. The primary collimator defines a plurality of rows of slits. Each slit and each row of slits is separated by an x-ray absorbing material. Each of the rows of slits oriented to transmit at least one x-ray slit-beam in a plane substantially orthogonal to the primary collimator.

### BACKGROUND OF THE INVENTION

1. Field of the Invention

The embodiments described herein relate generally to security systems and, more particularly, to an x-ray diffraction imaging device and an object imaging system having such x-ray diffraction imaging device.

2. Description of Related Art

Many known security systems include an object imaging system that is configured with fan-beam detection technology employing known x-ray diffraction imaging (XDI) devices. Many of these known fan-beam XDI devices include at least one x-ray source to generate a single x-ray fan-beam having multiple photon energies. These screening devices also include a first, or primary collimator that facilitates forming the fan-beam. Such devices further include at least one x-ray detector and at least one second collimator that receive at least a portion of a scatter x-ray flux subsequent to interaction of the fan-beam with a piece of the item. The x-ray detector receives at least a portion of the scatter x-ray flux and generates a detector response in the form of a detector signal that is subsequently used to generate an image of the object as discussed further below. These known security systems, wherein such devices are embedded, use coherent x-ray scatter techniques to screen individuals' baggage items with a fan-beam that illuminates a portion of the item, thereby forming an interrogation volume within the item. Such security systems also generate a two-dimensional (2-D) cross-sectional image that facilitates discovery of contraband items and substances.

Many known fan-beam x-ray diffraction imaging devices use a direct fan-beam (DFB) geometry to attain a predetermined spatial resolution. In the DFB geometry, an object is positioned within an object space that is divided into a plurality of three-dimensional volume elements, i.e., voxels. Portions of the fan-beam generated by the x-ray source are channeled through the primary collimator into the object space. A portion of the x-rays that interact with the object are scattered from the voxel where the interaction occurred and at least a portion of such scattered x-rays are channeled through the secondary collimator to the detector. Spatial resolution is a quality measurement defining an ability of an imaging device to identify a particular detected scattered x-ray to have been scattered from a particular voxel. Many of the known fan-beam x-ray diffraction imaging devices are configured such that at least some of the scattered x-rays detected originate from a border region between two voxels, or originate from another, unidentified voxel. Such cross-talk scattering of x-rays is referred to as voxel overlap. To improve spatial resolution, i.e., decrease a number of scattered x-rays that are detected from an undesired voxel, primary and secondary collimators are configured to decrease potential areas of overlap in the object space by introducing detection gap regions in the object space. Portions of the object under inspection within these detection gap regions are not irradiated. The fan-beam generated by the device irradiates only a portion of the object and movement of the x-ray source and/or the detector is required to irradiate the entire object. Scanning of such objects using such known devices requires additional time to scan the entire object.

In addition, many of such known fan-beam x-ray diffraction imaging devices include components that are arranged and configured to facilitate mechanical movement of either, or all of, the x-ray source, the collimators, and the detector. Such mechanical movement requires motive components that increase the size, weight, and cost of the device. Moreover, such motive components typically require routine inspections, preventative maintenance activities, and occasional corrective maintenance activities. Further, owners will typically maintain a spare parts inventory associated with mechanical movement. The aforementioned activities and spare parts inventories tend to increase a total cost of ownership of the fan-beam x-ray diffraction imaging devices.

Moreover, many known fan-beam x-ray diffraction imaging devices include secondary collimators with symmetrical apertures through which scattered x-rays are transmitted before reaching the detector. Such collimators facilitate cross-talk scattering of x-rays, i.e., directing scattered x-rays that propagate through the secondary collimator from undesired voxels to combine with desired, or legitimate scattered x-rays from the desired voxels to reach the detector and generate false alarms for certain contraband materials and substances. Such false alarms typically require manual inspection of the associated items with the additional costs of security resources to conduct the inspection and inconvenience to both the owner of the associated items and the security resources. Moreover, such secondary collimators permit only a small proportion of the useful scatter x-ray beam to reach the detector and therefore limit the detector signal, thereby decreasing a potential for legitimate detections. As a consequence of the small detector signal the detection efficiency is impaired. Accordingly, it would be desirable to provide a fan-beam x-ray diffraction imaging device with a method of operation that decreases and/or eliminates movement of the device components and reduces the detection gap regions to permit the entire useful scatter x-ray beam to reach the detector while also reducing the passage of cross-talk x-rays through the secondary collimator.

### BRIEF SUMMARY OF THE INVENTION

In one aspect, an x-ray diffraction imaging (XDI) device is provided. The XDI device includes at least one x-ray source configured to emit an x-ray fan-beam. The XDI device also includes a primary collimator positioned downstream of the at least one x-ray source. The primary collimator defines a plurality of rows of slits. Each slit and each row of slits is separated by an x-ray absorbing material. Each of the rows of slits oriented to transmit at least one x-ray slit-beam in a plane substantially orthogonal to the primary collimator.

In another aspect, an x-ray diffraction imaging (XDI) device is provided. The XDI device includes a primary collimator that includes an x-ray absorbing material that defines a plurality of slits therein. The plurality of slits defines at least one row of slits extending in a first dimension in a first plane. The XDI device also includes a secondary collimator positioned downstream of the primary collimator. The secondary collimator defines an aperture that defines a substantially quadrilateral detection volume that defines a plurality of detection volume edges and an aperture opening angle therebetween. Each of the plurality of detection volume edges intersects a portion of the x-ray absorbing material. The x-ray absorbing material at least partially defines adjacent slits in the at least one row of slits.

In still another aspect, an object imaging system is provided. The object imaging system includes at least one computer processor and a traveling belt. The object imaging system also includes an x-ray diffraction imaging (XDI) device coupled to the at least one computer processor. The XDI device includes at least one x-ray source configured to emit an x-ray fan-beam. The XDI device also includes a primary collimator positioned downstream of the at least one x-ray source. The primary collimator defines a plurality of rows of slits. Each slit and each row of slits is separated by an x-ray absorbing material. Each of the rows of slits is oriented to transmit at least one x-ray slit-beam. The XDI device further includes a secondary collimator positioned downstream of the primary collimator. The primary collimator and the secondary collimator define an object space therebetween. At least a portion of the travelling belt extends through the object space. The x-ray absorbing material masks portions of the x-ray fan-beam emitted from the x-ray source from the object space.

Embodiments of the method and device described herein facilitate effective and efficient operation of a security system by decreasing time of using, and costs of owning, a fan-beam x-ray diffraction imaging device for the associated security system. The x-ray diffraction imaging device described herein significantly decreases mechanical movements of the imaging device components and facilitates substantial parallel imaging and analysis of items under scrutiny. Therefore, the method and imaging device disclosed herein significantly increases the useful scatter signal incident on the scatter detector and also decreases a probability of a cross-talk x-ray arriving at the detector, thereby increasing detection efficiency and decreasing a probability of false alarm generation for contraband substances and materials.

### BRIEF DESCRIPTION OF THE DRAWINGS

FIGS. 1-11 show exemplary embodiments of the imaging devices, systems, and methods described herein.

FIG. 1 is a schematic view of an exemplary security system.

FIG. 2 is a schematic perspective view of an exemplary fan-beam x-ray diffraction imaging (XDI) device that may be used with the security system shown in FIG. 1.

FIG. 3 is a schematic cross-sectional view of a portion of the fan-beam XDI device shown in FIG. 2.

FIG. 4 is a schematic cross-sectional view of a portion of the fan-beam XDI device shown in FIG. 2.

FIG. 5 is a schematic cross-sectional view of an exemplary primary collimator that may be used in the fan-beam XDI device shown in FIG. 2.

FIG. 6 is a schematic cross-sectional view of a portion of the fan-beam XDI device shown in FIG. 2.

FIG. 7 is a schematic cross-sectional view of a portion of the fan-beam XDI device shown in FIG. 2.

FIG. 8 is a schematic cross-sectional view of a portion of the fan-beam XDI device shown in FIG. 2.

FIG. 9 is a schematic cross-sectional view of a portion of the fan-beam XDI device shown in FIG. 2.

FIG. 10 is a schematic cross-sectional view of a portion of the fan-beam XDI device shown in FIG. 2.

FIG. 11 is a schematic cross-sectional view of a portion of an alternative fan-beam XDI device that may be used with the security system shown in FIG. 1.

### DETAILED DESCRIPTION OF THE INVENTION

The method and fan-beam x-ray diffraction imaging (XDI) devices described herein facilitate effective and efficient operation of security systems. The security systems include an effective fan-beam XDI device that significantly decreases mechanical movements of the imaging device components and facilitates substantial parallel imaging and analysis of items under scrutiny. Such XDI device includes a multi-plane primary collimator that generates a plurality of x-ray fan-beams in which a plurality of detection volumes in a three-dimensional (3-D) object space are analyzed in parallel to generate a two-dimensional (2-D) image of an object and items residing therein. Such XDI device also includes a multi-plane secondary collimator that transmits a divergent scatter x-ray fan beam utilizing a large portion of the useful scattered x-rays while decreasing cross-talk x-rays. Therefore, such XDI device facilitates analyzing an energy-resolved spectra of the scattered x-rays with a 3-D resolution in the object space. The method and imaging device disclosed herein results in providing the user with a visual 2-D image of the items under scrutiny at a lower cost with faster results, substantially regardless of the physical attributes of the scrutinized items. Further, the method and imaging device disclosed herein results in increasing the signal of legitimate scattered x-rays while decreasing the number of cross-talk x-rays, thereby increasing the detection rate and decreasing a number of false alarms associated with contraband substances and materials. Moreover, the fan-beam XDI device described herein has a sufficiently small footprint to facilitate inclusion within many existing security checkpoints.

A first technical effect of the fan-beam XDI device and method described herein is to provide the user of the security system described herein with a reduction in the scanning time of each item being scrutinized. This first technical effect is at least partially achieved by substantially constant spatial resolution over an entire object space and substantially complete and simultaneous object irradiation. The first technical effect is also at least partially achieved by extending detection channel coverage of an object space with non-interfering detection volumes in at least two dimensions.

A second technical effect of the fan-beam XDI device and method described herein is to reduce capital, maintenance and operational costs associated with ownership of such security system. This second technical effect is at least partially achieved by reducing and/or eliminating detector movement and conveyor belt movement to perform 3-D scans, thus reducing a size and cost of the imaging device, including eliminating those devices necessary to execute such movements.

A third technical effect of the fan-beam XDI device and method described herein is to increase detection rate and reduce the number of false alarms associated with contraband substances and materials. This third technical effect is at least partially achieved by spatial resolution over substantially an entire object space, thereby significantly reducing scatter x-ray cross-talk.

A fourth technical effect of the fan-beam XDI device and method described herein is a broader energy spectrum of detected x-rays with a greater granularity of the spectrum. This fourth technical effect is at least partially achieved by discriminating scattering angles of the scattered x-rays, and the associated energies thereof, with greater statistical certainty of results associated with scattered x-ray detection.

The third and fourth technical effects are primarily achieved by using a masked dual fan-beam (MDFB) configuration that facilitates masking portions of a large fan-beam from an object space. Adjacent x-ray streams, or slit-beams are substantially isolated from each other while forming a plurality of x-ray-irradiated portions of the object space. The adjacent slit-beams have substantially no overlap while substantially all of the object space is irradiated.

At least one embodiment of the present invention is described below in reference to its application in connection with and operation of a security system for monitoring, alarming, and notification. However, it should be apparent to those skilled in the art and guided by the teachings provided herein that a plurality of embodiments of the invention are likewise applicable to any suitable system requiring security screening of a large number of items of varying shapes in a short time frame with little to no false alarms.

At least some of the components of the object imaging systems and security systems described herein include at least one processor and a memory, at least one processor input channel, and at least one processor output channel. As used herein, the term “processor” is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may include, without limitation, computer peripherals associated with an operator interface such as a mouse and a keyboard. Alternatively, other computer peripherals may also be used that may include, for example, without limitation, a scanner. Furthermore, in the exemplary embodiment, additional output channels may include, without limitation, an operator interface monitor.

The processors as described herein process information transmitted from a plurality of electrical and electronic components that may include, without limitation, security system inspection equipment such as fan-beam x-ray diffraction imaging devices. Such processors may be physically located in, for example, but not limited to, the fan-beam x-ray diffraction imaging devices, desktop computers, laptop computers, PLC cabinets, and distributed control system (DCS) cabinets. RAM and storage devices store and transfer information and instructions to be executed by the processor. RAM and storage devices can also be used to store and provide temporary variables, static (i.e., non-changing) information and instructions, or other intermediate information to the processors during execution of instructions by the processors. Instructions that are executed include, without limitation, resident security system control commands. The execution of sequences of instructions is not limited to any specific combination of hardware circuitry and software instructions.

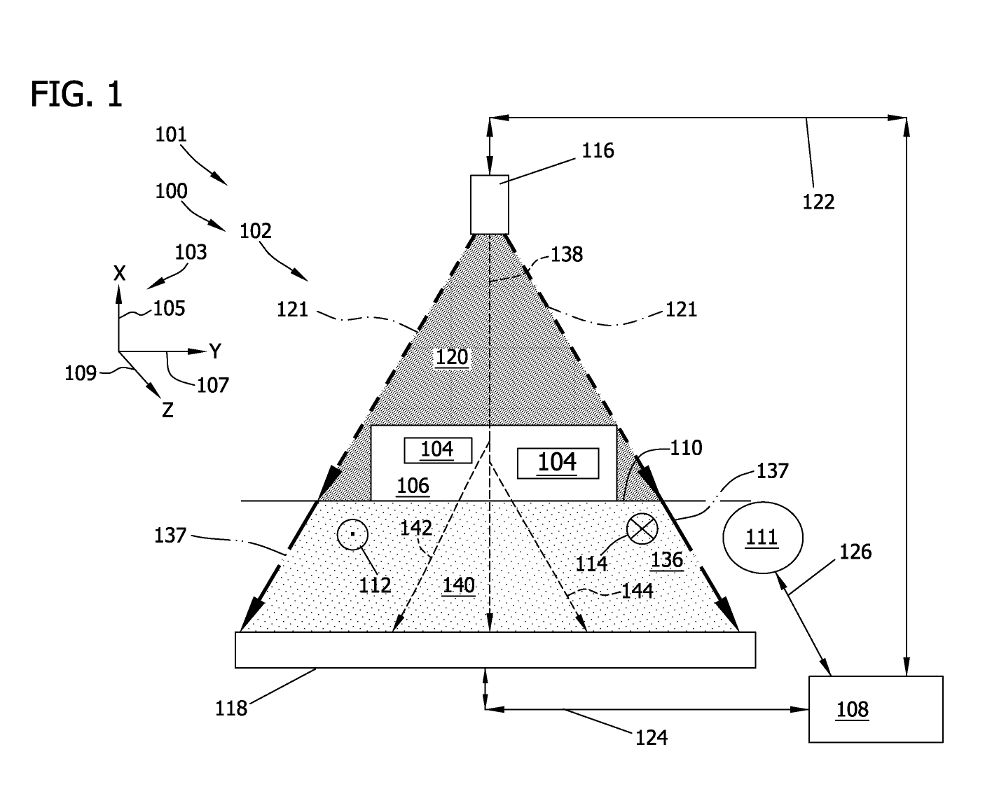

FIG. 1 is a schematic view of an exemplary object imaging system 100 including an exemplary direct fan-beam (DFB) x-ray diffraction imaging (XDI) device 102. In the exemplary embodiment, object imaging system 100 is integrated within a larger, more comprehensive security system 101. Security system 101 is configured to operate both for checked luggage and carry-on luggage in airport security as well as at security checkpoints (not shown) where it is configured to scan larger-profile items, such as suitcases and shipping crates. Also, in the exemplary embodiment, XDI device 102 is a massively-parallel stationary x-ray XDI device, or, a fourth generation, multi-plane DFB XDI device. Such fourth generation XDI devices are characterized with a measurement rate in excess of 10,000 object volume elements (voxels) per second with an energy-resolved spectra of the scattered x-rays and with a 3-D resolution in the object space as compared to first generation XDI devices (approximately 1 voxel per second), second generation XDI devices (approximately 100 voxels per second), and third generation XDI devices (approximately 10,000 voxels per second) without such spectral and spatial resolution.

In the exemplary embodiment, object imaging system 100 is configured to inspect items that include, without limitation, objects 104 of varying sizes that may be carried by individuals (not shown) in their associated luggage 106. Alternatively, object imaging system 100 is used to inspect any items including, without limitation, checked luggage and freight parcels. Moreover, in the exemplary embodiment, object imaging system 100 includes at least one computer processor, i.e., a computer processing system 108. Computer processing system 108 includes sufficient information technology resources to record, analyze, synthesize and correct data collected. The information technology resources may include, without limitation, processing, memory, and input/output (I/O) resources as described above. Data processing techniques provide the technical effect of forming a two-dimensional (2-D) image representative of objects 104 and luggage 106 and contents therein.

Computer processing system 108 may include equipment (not shown) such as, without limitation, printers, desk top computers, laptop computers, servers, and hand-held devices, such as personal data assistants (PDAs), that perform system and network functions that include, without limitation, diagnostics, reporting, technical support, configuration, system and network security, and communications.

As described above, in the exemplary embodiment, object imaging system 100 includes computer processing system 108 and the resources of processing system 108 are dedicated to object imaging system 100. Alternatively, computer processing system 108 may be a part of and/or integrated within a larger processing system (not shown) associated with a remainder (not shown) of security system 101. That is, computer processing system 108 may be coupled with other systems and networks (neither shown) via a local area network (LAN) or Wide Area Network (WAN) (neither shown). Moreover, computer processing system 108 may be coupled with other systems and networks including, but not limited to, a remote central monitoring station via the Internet and/or a radio communications link (neither shown), wherein any network configuration using any communication coupling may be used. Alternatively, in contrast to being a portion of a larger system, computer processing system 108 may be solely associated with XDI device 102.

For illustration and perspective, FIG. 1 shows a coordinate system 103 that includes an x-axis 105 (substantially representing a vertical dimension), a y-axis 107 (substantially representing a horizontal, longitudinal, or lengthwise dimension), and a z-axis 109 (substantially representing a depth, traverse, or widthwise dimension). Each axis is orthogonal to each other axis. In the exemplary embodiment, defining orientation of object imaging system 100, security system 101, and DFB XDI device 102 with coordinate system 103 as described herein facilitates consistent perspective within this disclosure. Alternatively, any orientation of systems 100 and 101 and XDI device 102 may be used, without limitation, that enables systems 100 and 101 and XDI device 102 as described herein.

Object imaging system 100 also includes a traveling belt 110 and belt drive apparatus 111. Belt drive apparatus 111 is operatively coupled in motive operation of belt 110. Belt drive apparatus 111 includes at least one of an electric drive motor, a hydraulic drive motor, a pneumatic motor, and/or a gearbox (not shown), and/or any other suitable device. Belt drive apparatus 111 drives belt 110 primarily in the substantially longitudinal, or lengthwise direction, or orientation as indicated by a bi-directional belt drive direction arrow 112 substantially parallel to z-axis 109 and is shown to be exiting FIG. 1. Belt drive apparatus 111 is reversible such that belt 110 also travels with an oscillating motion in the substantially longitudinal, or lengthwise direction, or orientation as indicated by a bidirectional arrow 114 substantially parallel to z-axis 109 and is shown to be entering and exiting FIG. 1. Belt drive apparatus 111 drives belt 110 to travel in a direction reverse to that of belt drive direction arrow 112 and then drives belt 110 to travel in the direction of direction arrow 112 to facilitate multiple scans by XDI device 102. One technical effect of exemplary DFB XDI device 102 as described herein is to reduce a necessity for using such reversible features of belt drive apparatus 111 and belt 110.

In the exemplary embodiment, XDI device 102 includes at least one x-ray source and primary collimator combination 116 and at least one scatter, or secondary collimator and x-ray detector combination 118. X-ray source/primary collimator combination 116 and secondary collimator/x-ray detector combination 118 include devices as described herein (and further below) and may otherwise include any suitable devices known in the art. X-ray source/primary collimator combination 116 is configured to generate and transmit a primary x-ray fan-beam 120 and secondary collimator/x-ray detector combination 118 is configured to receive at least a portion both of a scattered x-ray beam (discussed further below), as well as at least a portion of primary x-ray fan-beam 120 as defined by primary x-ray fan-beam edges 121.

Luggage 106 is positioned downstream of X-ray source/primary collimator combination 116 and is illuminated by at least a portion of primary x-ray fan-beam 120. At least a portion of primary x-ray fan-beam 120 passes through and/or around luggage 106 with little or no interaction, thereby forming an unscattered x-ray fan-beam 136 as defined by unscattered x-ray fan-beam edges 137. In the exemplary embodiment, one primary x-ray 138 from primary x-ray fan-beam 120 is illustrated to interact with luggage 106 to form a first scatter ray 142. Primary x-ray 138 then transits through luggage 106 to form a second scatter ray 144. The undeflected primary x-ray 138 eventually exits the object. X-ray scatter forms a scatter, or secondary x-ray beam 140 that is induced along the entire path of primary x-ray 138 in the object. Primary x-ray 138 and secondary x-ray beam 140 including at least scatter rays 142 and 144 are discussed further below. Generation, transmission, and receipt of primary x-ray fan-beam 120 and secondary x-ray beam 140 are collectively referred to herein as a “shot”.

In the exemplary embodiment, x-ray source/primary collimator combination 116, secondary collimator/x-ray detector combination 118, secondary x-ray beam 140 and x-ray fan-beam 120 includes a transverse orientation with respect to bidirectional arrow 114. Alternatively, combinations 116 and 118 and beams 120 and 140 have any orientation that enables object imaging system 100, security system 101, and DFB XDI device 102, each as described herein. Also, in the exemplary embodiment, combinations 116 and 118 and beams 120 and 140 are substantially stationary. Such substantially stationary configuration facilitates reducing movements of combinations 116 and 118, primary fan-beam 120, and secondary x-ray beam 140 and oscillating travel of belt 110 via belt drive apparatus 111, thereby facilitating extending an expected operational lifetime of those components associated with such movement and decreasing a period of time associated with scanning of objects 104 and luggage 106. Moreover, eliminating such movement facilitates elimination of associated components, such as, without limitation, oscillating features of belt drive apparatus 111 and belt 110, thereby facilitating decreasing a cost and footprint of object imaging system 100, security system 101, and XDI device 102.

In the exemplary embodiment, computer processing system 108 is coupled with components of object imaging system 100 including x-ray source/primary collimator combination 116, secondary collimator/x-ray detector combination 118, and belt drive belt drive apparatus 111 via communication conduits 122, 124, and 126, respectively. Computer processing system 108 substantially controls and coordinates operation of combinations 116 and 118 and belt drive apparatus 111 to illuminate objects 104 and luggage 106 with x-ray fan-beam 120 as described herein.

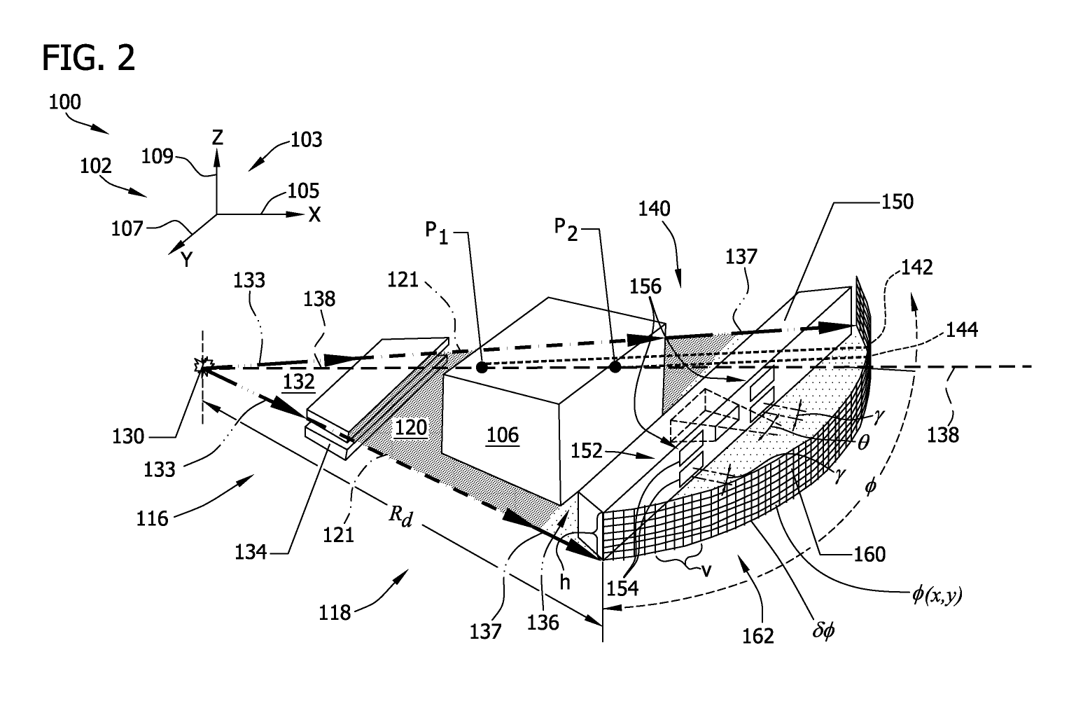

FIG. 2 is a schematic perspective view of exemplary fan-beam XDI device 102 that may be used with the security system shown in FIG. 1. As discussed above, XDI device 102 is a fourth generation, stationary, multi-plane, DFB XDI device with a measurement rate of approximately 10,000 object volume elements (voxels) per second. Coordinate system 103, including x-axis 105 (substantially representing a vertical dimension), y-axis 107 (substantially representing a horizontal, longitudinal, or lengthwise dimension), and z-axis 109 (substantially representing a depth, traverse, or widthwise dimension) are shown for consistent perspective.

In the exemplary embodiment, as discussed above, multi-plane DFB XDI device 102 includes an x-ray source/primary collimator combination 116. Combination 116 includes an x-ray radiation source 130 that, in the exemplary embodiment, generates and transmits a substantially polychromatic x-ray stream 132 as defined by x-ray stream edges 133. Radiation source 130 is positioned at the origin of coordinate system 103. Alternatively, without limitation, radiation source 130 is any source emitting any form of radiation that enables XDI device 102 as described herein. Combination 116 also includes a primary collimator 134 that is positioned downstream of radiation source 130. In the exemplary embodiment, DFB XDI device 102 includes a single primary collimator. Alternatively, XDI device 102 includes a plurality of primary collimators 134. Primary collimator 134 receives at least a portion of x-ray stream 132 that is incident on primary collimator 134 and forms thin fan-beam, or primary x-ray fan-beam 120 as defined by primary x-ray beam edges 121. In the exemplary embodiment, primary x-ray fan-beam 120 is substantially formed in an x-y plane (not shown) defined by x-axis 105 and y-axis 107 and has a thickness value of approximately 1 millimeter (mm), or less, as measured in the dimension defined by z-axis 109, wherein an x-z plane (not shown) is defined by x-axis 107 and z-axis 109. With the exception defining x-ray beam edges 121 on primary x-ray fan-beam 120, there is no primary collimation in the direction of y-axis 107.

Luggage 106 is positioned downstream of primary collimator 134 and is illuminated by at least a portion of primary x-ray fan-beam 120. At least a portion of primary x-ray fan-beam 120 passes through luggage 106 with little or no interaction, thereby forming an unscattered x-ray fan-beam 136 as defined by unscattered x-ray fan-beam edges 137. In the exemplary embodiment, one primary x-ray 138 from primary x-ray fan-beam 120 is illustrated to transmit through primary collimator 134 and interact with luggage 106 at point P₁ to form a first scatter ray 142. It then transits through luggage 106 to a point P₂ to form a second scatter ray 144. The undeflected primary x-ray 138 eventually exits luggage 106. Points P₁ and P₂ are shown for illustration. X-ray scatter forms a scatter, or secondary x-ray beam 140 and is induced along the entire path of x-ray 138 in the object. Primary x-ray 138 and secondary x-ray beam 140 including at least scatter rays 142 and 144 are discussed further below.

Also, in the exemplary embodiment, as discussed above, multi-plane DFB XDI device 102 includes a secondary collimator/detector combination 118. Combination 118 includes a scatter, or secondary collimator 150. Secondary collimator 150 defines a two-dimensional arrangement of quadrilateral passages 152 defined by a plurality of lamella (not shown). For clarity in FIG. 2, only five passages 152 are shown, only one passage 152 is shown extending through secondary collimator 150, and the size of passages 152 is exaggerated. Passages 152 include a plurality of quadrilateral passages 154 in the horizontal (x-y) plane and a plurality of quadrilateral passages 156 in the vertical (y-z) plane. Such quadrilateral passages 152, 154, and 156 are typically, and hereon, referred to as apertures 152, 154, and 156. Horizontal apertures 154 have widths of approximately 10 mm and are spaced approximately 10 mm apart from each other. Only two rows of horizontal apertures 154 are shown for clarity. Vertical apertures 156 are oriented at an angle γ to the x-y (horizontal) plane that increases along z-axis 109, are spaced approximately 1 mm apart from each other, and also converge at a focus defined by radiation source 130. Only three columns of vertical apertures 156 are shown for clarity.

Alternatively, the dimensions of vertical apertures 156 and horizontal apertures 154 may be interchanged. Moreover, alternatively, horizontal apertures 154 and vertical apertures 156 have any number, sizing, configuration, and orientation that enables operation of XDI device 102 as described herein. Each of apertures 152 defines an opening angle θ that extends in the direction of y-axis 107 in the x-y plane as is discussed further below.

Further, in the exemplary embodiment, combination 118 includes a detector array 160 positioned immediately downstream of secondary collimator 150. Detector array 160 is a 2-D pixellated detector array that is fabricated from, without limitation, energy-resolving detector materials that include compounds of cadmium, zinc, and tellurium, for example, without limitation, CdZnTe. Detector array 160 includes a plurality of detector channels 162, wherein channels 162 define a plurality of vertical columns “v” and a plurality of horizontal rows “h” about an angular range of φ. Each detector channel 162 is defined by an h and φ coordinate, i.e., channel (h, φ) 162. φ is also defined as the total angle defined by primary fan-beam 120 as bounded by primary x-ray beam edges 121 in the x-y plane. φ(x,y) is defined as a position, or angular coordinate, along angular range φ with coordinates x and y corresponding to x-axis 105 and y-axis 107, respectively. Combinations 116 and 118 are oriented and configured to facilitate x-ray radiation transmitted through luggage 106 to form unscattered x-ray fan-beam 136 that is recorded in the lowest row (h=0, γ=0) of detector array 160.

In the exemplary embodiment, for primary x-ray 138 of fan-beam 132 having position φ(x,y) in the x-y plane, secondary collimator 150 passes secondary x-ray beam 140, including scatter rays 142 and 144, with angular position φ and a vertical position z relative to the x-y plane. One set of vertical quadrilateral passages 156 with a substantially similar φ(x,y) position value within secondary collimator 150 facilitates restricting a certain detector column v to “see” predetermined object volumes (not shown) lying in a narrow strip of angular width, or partial arc δφ about angular range φ of detector array 160. Moreover, one set of horizontal quadrilateral passages transmits only radiation scattered at an approximately congruent with angle γ relative to primary x-ray 138. As discussed further below, a known relationship exists between x-ray scatter angles and scattered x-ray energies. An energy spectrum of x-rays scattered at a predetermined angle from a small region of luggage 106 into secondary collimator 150 and a certain detector channel (h, φ)) 162 is determined. Such energy spectrum is processed to yield a diffraction profile of material in this small region.

XDI device 102 includes radiation source 130, primary collimator 134, secondary collimator 150, and detector array 160 located at a radial distance R_{d} from radiation source 130. In the exemplary embodiment, a technical effect of illuminating luggage 106 with object imaging system 100 is that detector array 160 generates a plurality of energy spectra from a distribution of detection volumes (not shown in FIG. 2 and described further below) in luggage 106 and objects 104 (shown in FIG. 1) residing therein. Another technical effect of illuminating luggage 106 with object imaging system 100 is that computer processing system 108 analyzes the plurality of energy spectra in parallel to generate a 2-D x-ray diffraction image of luggage 106 and objects 104 residing therein.

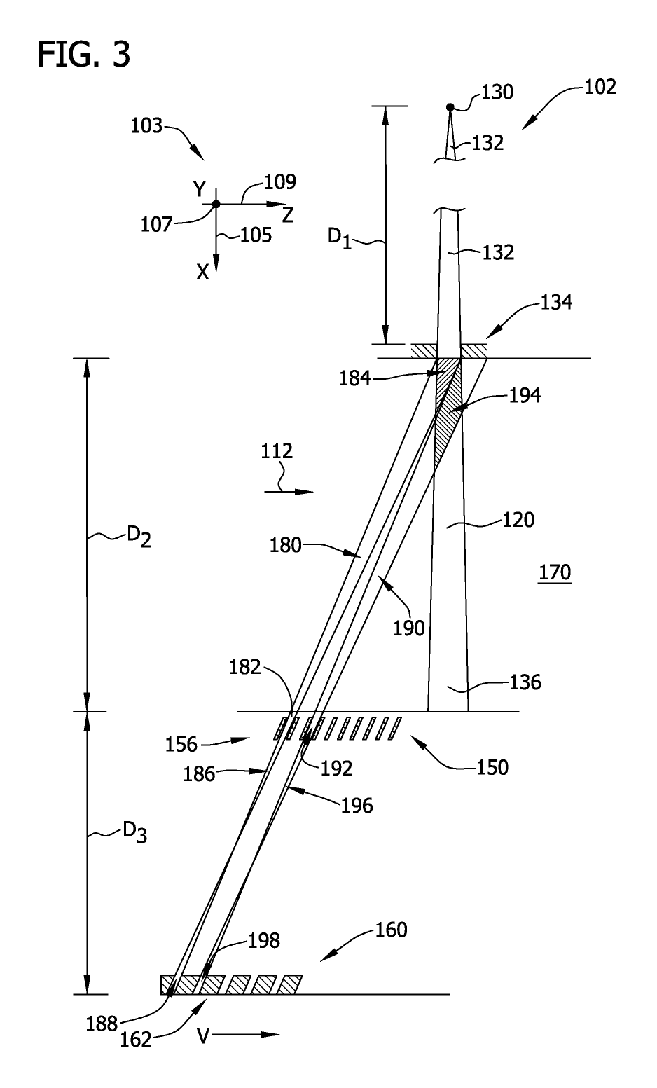

FIG. 3 is a schematic cross-sectional view of a portion of multi-plane DFB XDI device 102. Coordinate system 103, including x-axis 105, y-axis 107, and z-axis 109 are shown for consistent perspective. In the exemplary embodiment, x-ray radiation source 130 is positioned a first distance D₁ from primary collimator 134. An object space 170 is defined between primary collimator 134 and secondary collimator 150. Object space 170 does not necessarily extend through the entire region defined between primary collimator 134 and secondary collimator 150, however, object space 170 is sufficiently sized to receive luggage 106 (shown in FIG. 1). Belt direction arrow 112 is shown for perspective.

Also, in the exemplary embodiment, primary collimator 134 and secondary collimator 150 are separated by a second distance D₂ and secondary collimator 150 and detector array 160 are separated by a third distance D₃. A first secondary collimator detectable volume 180 is defined in object space 170 between a first vertical aperture 182 and primary collimator 134. First secondary collimator detectable volume 180 intersects a portion of primary x-ray fan-beam 120 to define a first irradiated volume 184. A first detector beam volume 186 is defined between first vertical aperture 182 and a first detector channel 188. Similarly, a second secondary collimator detectable volume 190 is defined in object space 170 between a second vertical aperture 192 and primary collimator 134. Second secondary collimator detectable volume 190 intersects a portion of primary x-ray fan-beam 120 to define a second irradiated volume 194. A second detector beam volume 196 is defined between second vertical aperture 192 and a second detector channel 198. Such configuration is continuous through an n^{th} secondary collimator detectable volume, an n^{th} irradiated volume, and an n^{th} detector beam volume that are defined by an n^{th} vertical aperture and an n^{th} detector channel (none shown in FIG. 3).

Therefore, in the exemplary embodiment, the arrangement of vertical apertures 156 in a direction along z-axis 109 and the number of detector channels 162 in detector array 160 cooperate to define a separation of object space 170 into discrete secondary collimator detection volumes 180 and 190 through the n^{th} secondary collimator detectable volume.

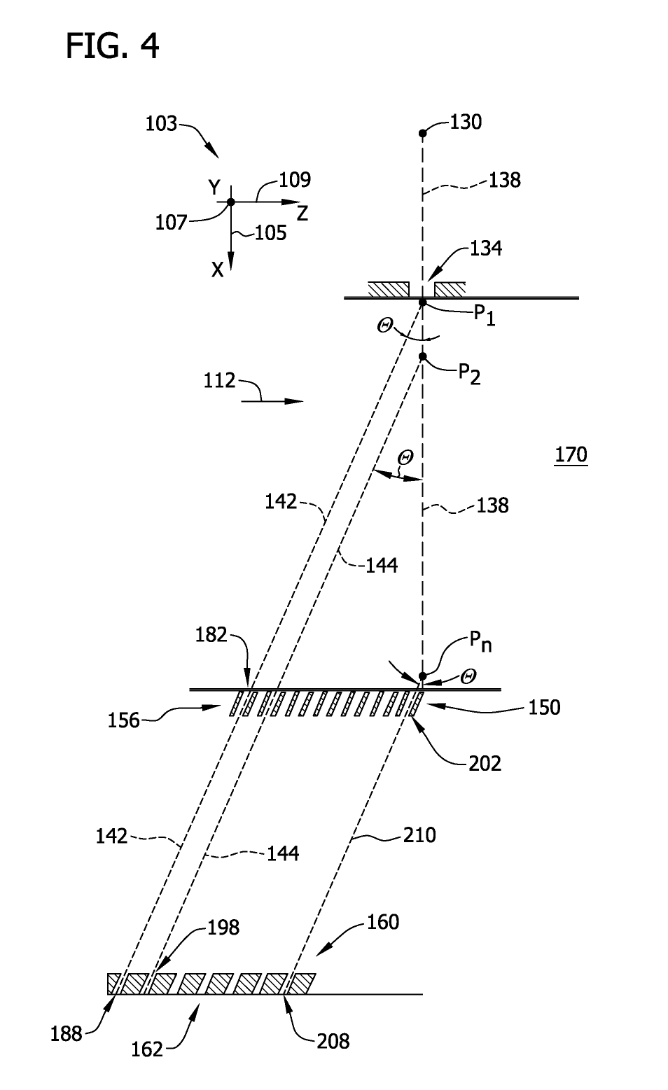

FIG. 4 is a schematic cross-sectional view of a portion of multi-plane DFB XDI device 102. Coordinate system 103, including x-axis 105, y-axis 107, and z-axis 109 are shown for consistent perspective. FIG. 4 is similar to FIG. 3 with the exception that, rather than showing first secondary collimator detection volume 180 and first detector beam volume 186 (both shown in FIG. 3), FIG. 4 shows first scatter ray 142 and associated scatter point P₁ in luggage 106 (shown in FIGS. 1 and 2). Scatter point P₁ is positioned in first secondary collimator detection volume 180 and first scatter ray 142 is scattered through first secondary collimator detection volume 180 and first detector beam volume 186. Similarly, rather than showing second secondary collimator detection volume 190 and second detector beam volume 196 (both shown in FIG. 3), FIG. 4 shows second scatter ray 144 and associated scatter point P₂ in luggage 106. Scatter point P₂ is positioned in second secondary collimator detection volume 190 and second scatter ray 144 is scattered through second secondary collimator detection volume 190 and second detector beam volume 196. Further, rather than showing x-ray stream 132 and primary x-ray fan-beam 120 (both shown in FIG. 3), FIG. 4 shows primary x-ray 138.

In the exemplary embodiment, secondary collimator 150 defines a number “n” of vertical apertures 156 including an n^{th} vertical aperture 202. Similarly, detector array 160 defines “n” detector channels 162 including an n^{th} detector channel 208. Also, in the exemplary embodiment, an n^{th} scatter ray 210 originates within luggage 106 at an n^{th} scatter point P. Scatter point Pₙ is positioned in an n^{th} secondary collimator detection volume (not shown in FIG. 4) and n^{th} scatter ray 210 is scattered through the n^{th} secondary collimator detection volume and an n^{th} second detector beam volume (not shown in FIG. 4).

Further, in the exemplary embodiment, each of scattered rays 142, 144, and 210 define a scattering angle Θ with primary x-ray 138 in the x-z plane, such scattering angle Θ is referenced to x-axis 105. In general, each detector channel and each secondary collimator aperture is aligned with a substantially similar scattering angle Θ. For example, without limitation, scattered ray 142 originates at point P₁ and is channeled through secondary collimator vertical aperture 182 to detector channel 188 at scatter angle Θ.

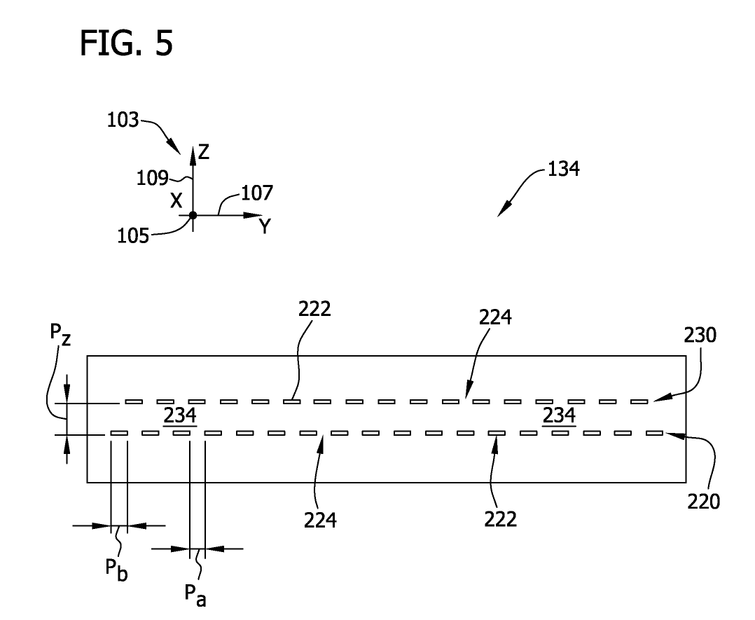

FIG. 5 is a schematic cross-sectional view of primary collimator 134 that may be used in fan-beam XDI device 102 (shown in FIG. 2). Coordinate system 103, including x-axis 105, y-axis 107, and z-axis 109 are shown for consistent perspective. Primary collimator 134 has a concave shape facing radiation source 130 (shown in FIGS. 2, 3, and 4) and a convex shape facing object space 170 (shown in FIGS. 3 and 4). However, for illustrative purposes, primary collimator 134 is shown in a substantially flat configuration. Alternatively, primary collimator 134 has a substantially flat configuration and the orientation and spacing of slits 222 and rows 220 and 230 are adjusted accordingly for example, without limitation, defining a length of each of slits 222 with a unique length in the direction of y-axis 107.

Primary collimator 134 defines a first row 220 of primary aperture slits 222 and a second row 230 of aperture slits 222. Each of aperture slits 222 in rows 220 and 230 are substantially rectangular and define a spacing Pₐ therebetween in the direction of y-axis 107. Such spacing is defined by a solid portion of primary collimator material 224. Also, each of aperture slits 222 has a length in a direction of y-axis 107 of P_{b}. In the exemplary embodiment, spacing Pₐ and length P_{b} are substantially congruent and are defined by a sizing and an orientation of horizontal apertures 154 of secondary collimator 150 (both shown in FIGS. 2, 3, and 4). Slits 222 in second row 230 are shifted in the direction of y-axis 107 a spacing of Pₐ (or, length P_{b}) with respect to slits 222 in first row 220. Alternatively, primary collimator 134 has any shape and any number of rows of aperture slits 222 with any spacing Pₐ therebetween and any length P_{b} that enables operation of primary collimator 134 as described herein. First row 220 and second row 230 of aperture slits 222 are separated by a portion of solid material 234 defining a distance in the direction of z-axis 109 of P_{z}. Distance P_{z} is further defined by a sizing and an orientation of vertical apertures 156 (shown in FIGS. 2, 3, and 4) of secondary collimator 150, scattering angle Θ, and distance P_{z} has any value that enables operation of primary collimator 134 as described herein.

In the exemplary embodiment, rows 220 and 230 define two substantially parallel x-y planes (not shown in FIG. 5) with a defined distance of P_{z} therebetween, thereby defining a masked dual fan-beam (MDFB) configuration. Radiation source 130 irradiates primary collimator 134 with x-ray stream 132 in the form of a fan-beam. Each aperture 222 facilitates a portion of x-ray stream 132 to be channeled through primary collimator 134. As described further below, the principle technical effect of rows 220 and 230 of slits 222 is to shift single x-ray stream 132 to define two substantially parallel planes of x-ray fan-beams, or x-ray slit-beams. Each stream of x-rays channeled through each slit 222 in first row 220 is offset from similar x-ray slit-beams from adjacent slits 222 in second row 230 in the direction of x-axis 105. Material 224 and material 234 facilitate masking adjacent x-ray slit-beams from each other while forming a plurality of x-ray-irradiated portions of object space 170 such that adjacent x-ray slit-beams have substantially no overlap while substantially all of object space 170 is irradiated. Each x-ray slit-beam irradiates a portion of object space 170 such that each x-ray slit-beams generates scattered x-rays substantially only in a particular portion of object space 170.

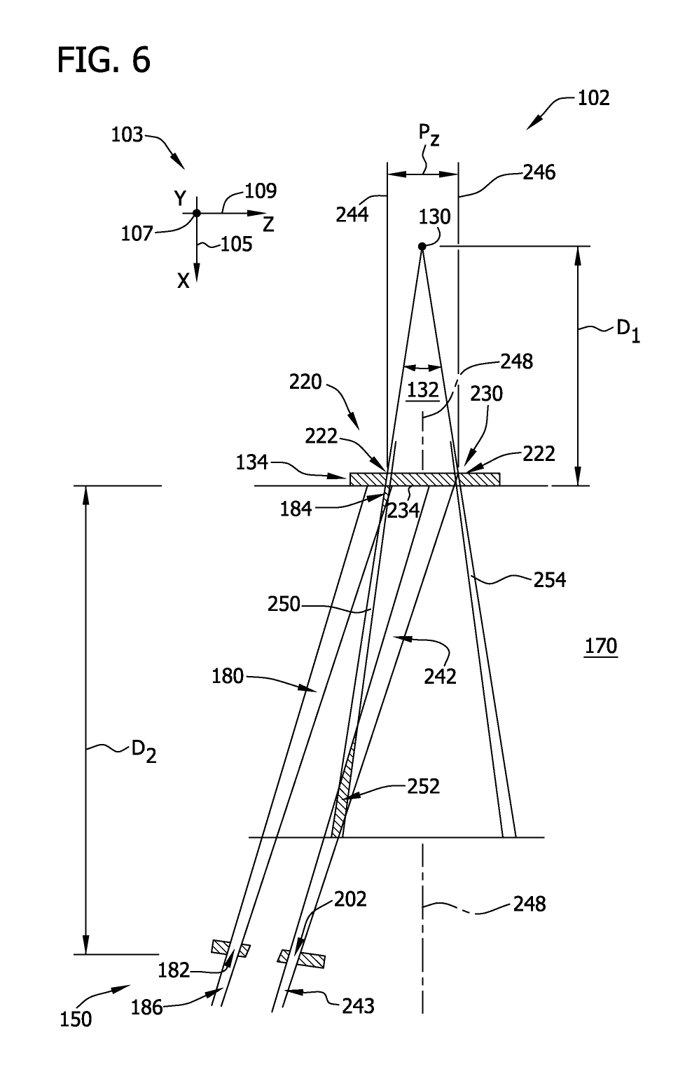

FIG. 6 is a schematic cross-sectional view of a portion of fan-beam XDI device 102. Coordinate system 103, including x-axis 105, y-axis 107, and z-axis 109 are shown for consistent perspective. Primary collimator 134 has a concave shape facing radiation source 130 and a convex shape facing object space 170. However, for illustrative purposes, primary collimator 134 is shown in a substantially flat configuration. In the exemplary embodiment, n^{th} vertical aperture 202 at least partially defines an n^{th} secondary collimator detectable volume 242 and an n^{th} n detector beam volume 243. Also, in the exemplary embodiment, first row of aperture slits 220 defines a first x-y plane 244 and second row of aperture slits 230 defines a second x-y plane 246. Planes 244 and 246 are substantially parallel with distance P_{z} defined therebetween, thereby defining a masked dual fan-beam (MDFB) configuration (discussed further below). Also, planes 244 and 246 may be considered to be a z⁺ plane and a z⁻ plane, respectively. Further, in the exemplary embodiment, fan-beam XDI device 102 defines a centerline 248 extending therethrough.

Primary collimator 134 is positioned between radiation source 130 and object space 170. A portion of x-ray stream 132, i.e., a first x-ray slit-beam 250 is channeled through apertures 222 (only one shown in FIG. 6) of first row 220. First x-ray slit-beam 250 intersects first secondary collimator detection volume 180 to define first irradiated volume 184 in object space 170. Similarly, first x-ray slit-beam 250 intersects n^{th} secondary collimator detectable volume 242 to define an n^{th} irradiated volume 252 in object space 170.

In the exemplary embodiment, a second x-ray slit-beam 254 (shown in phantom) is channeled through apertures 222 (shown shaded and only one shown in FIG. 6) of second row 230. Second row of aperture slits 230 is offset by spacing Pₐ (shown in FIG. 5) from first row of aperture slits 220 in the direction of y-axis 107, therefore, second x-ray slit-beam 254 is similarly offset, thereby substantially decreasing a potential for second x-ray slit-beam 254 to irradiate portions of first secondary collimator detection volume 180 through n^{th} secondary collimator detectable volume 242. Therefore, second x-ray slit-beam 254 is masked from detection volumes 180 through 242.

Also, in the exemplary embodiment, a minimum angle α is defined between first x-ray slit-beam 250 and second x-ray slit-beam 254. Angle α is further defined as the minimum x-ray fan spread angle required to define first irradiated volume 184 through n^{th} irradiated volume 252 in object space 170. Therefore, since first irradiated volume 184 is at least partially defined within first secondary collimator detection volume 180 and n^{th} irradiated volume 252 is at least partially defined within n^{th} secondary collimator detection volume 242, sizing and orientation of secondary collimator 150 at least partially defines angle α. Further, in the exemplary embodiment, angle α is geometrically related to row separation distance P_{z} and distance D₁ between primary collimator 134 and radiation source 130.

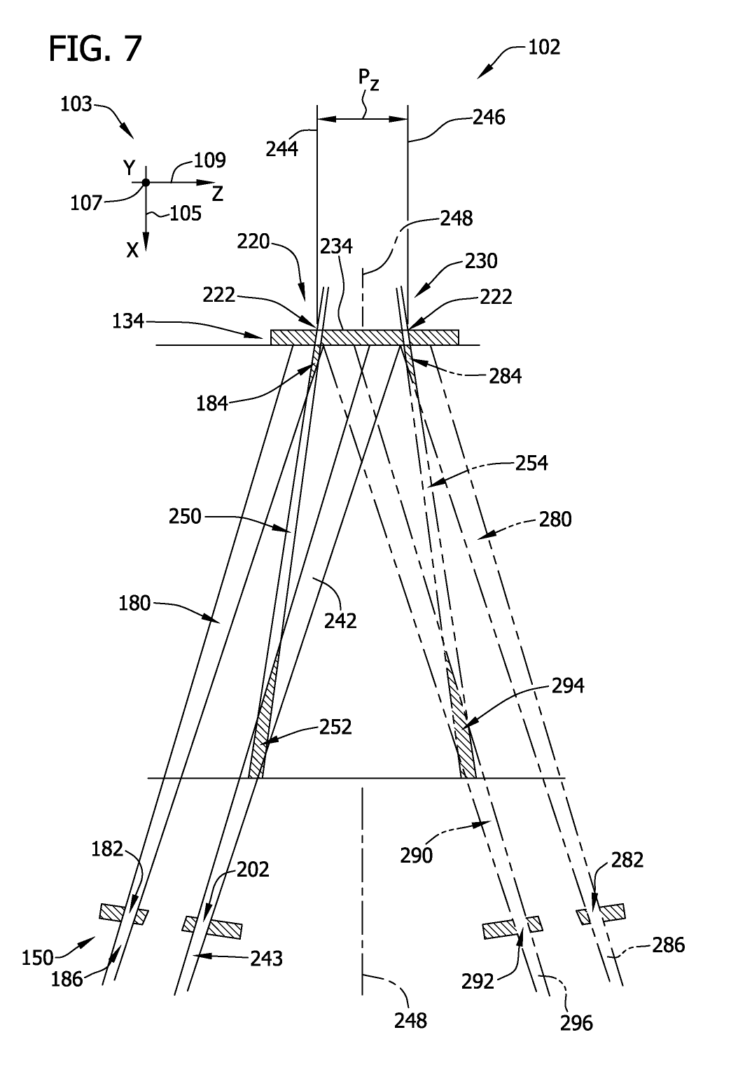

FIG. 7 is a schematic cross-sectional view of a portion of the fan-beam XDI device 102. Coordinate system 103, including x-axis 105, y-axis 107, and z-axis 109 are shown for consistent perspective. Primary collimator 134 has a concave shape facing radiation source 130 and a convex shape facing object space 170. However, for illustrative purposes, primary collimator 134 is shown in a substantially flat configuration. In the exemplary embodiment, secondary collimator 150 is substantially symmetrical about centerline 248. Therefore, in a manner substantially similar to that discussed for FIGS. 3 and 6, an n+1 secondary collimator detectable volume 280 is defined in object space 170 between an n+1 vertical aperture 282 and primary collimator 134. n+1 secondary collimator detectable volume 280 intersects a portion of second x-ray slit-beam 254 to define an n+1 irradiated volume 284 in object space 170. An n+1 detector beam volume 286 is defined between n+1 vertical aperture 282 and an n+1 detector channel (not shown in FIG. 7).

Similarly, a 2n^{th} secondary collimator detectable volume 290 (shown in phantom) is defined in object space 170 between a 2n^{th} vertical aperture 292 and primary collimator 134. 2n^{th} secondary collimator detectable volume 290 intersects a portion of second x-ray slit-beam 254 (shown in phantom) to define a 2n^{th} irradiated volume 294 in object space 170. A 2n^{th} detector beam volume 296 (shown in phantom) is defined between 2n^{th} vertical aperture 292 and a 2n^{th} detector channel (not shown in FIG. 7).

As described above for FIG. 6, in the exemplary embodiment, second x-ray slit-beam 254 (shown in phantom) is channeled through apertures 222 of second row 230 (shown shaded and only one shown in FIG. 7). Second row of aperture slits 230 is offset a distance equivalent to spacing Pₐ (shown in FIG. 5) from first row of aperture slits 220 in the direction of y-axis 107, therefore, second x-ray slit-beam 254 is similarly offset, thereby substantially decreasing a potential for second x-ray slit-beam 254 to irradiate portions of first secondary collimator detection volume 180 through n^{th} secondary collimator detectable volume 242. Therefore, second x-ray slit-beam 254 is masked from detection volumes 180 through 242.

Moreover, n+1 vertical aperture 282 through 2n^{th} vertical aperture 292 are shifted horizontally in the direction of y-axis 107. Furthermore, n+1 secondary collimator detectable volume 280 through 2n^{th} secondary collimator detectable volume 290 are shifted horizontally in the direction of y-axis 107 by approximately a distance equivalent to spacing Pₐ such that a potential for overlap with first secondary collimator detectable volume 180 through n^{th} secondary collimator detectable volume 242 is significantly reduced. Similarly, n+1 irradiated volume 284 through 2n^{th} irradiated volume 294 and n+1 detector beam volume 286 through 2n^{th} detector beam volume 296 are shifted horizontally in the direction of y-axis 107 by approximately a distance equivalent to spacing Pₐ.

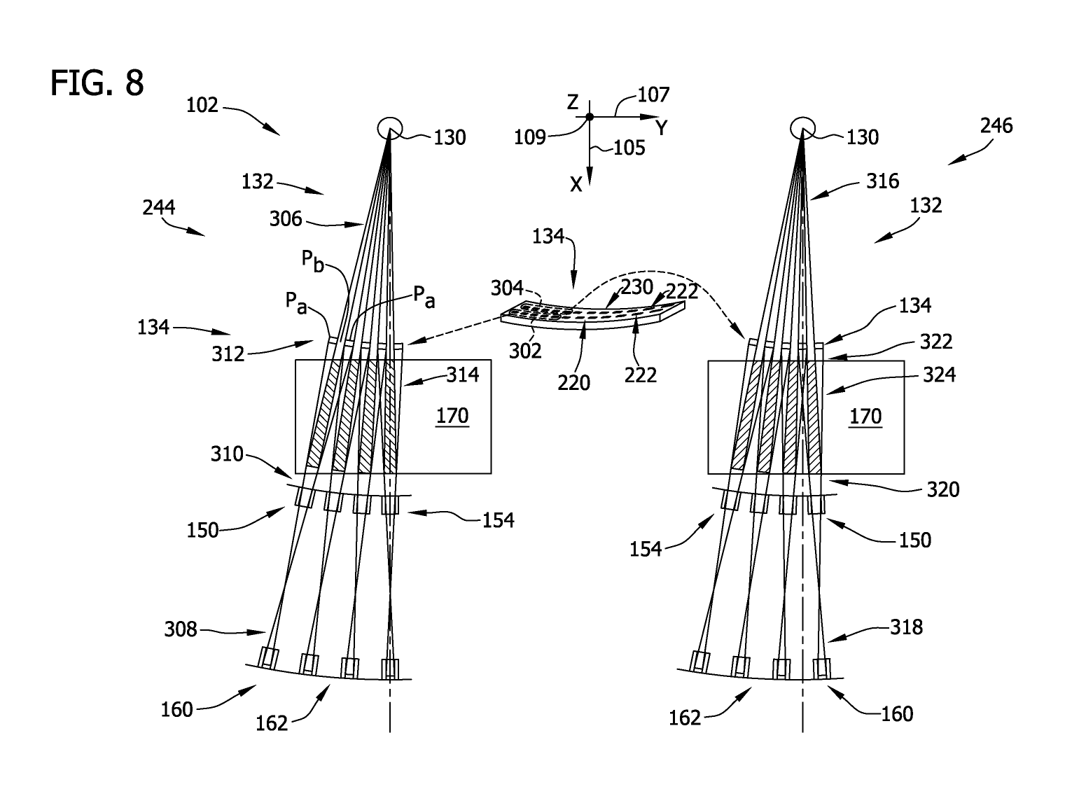

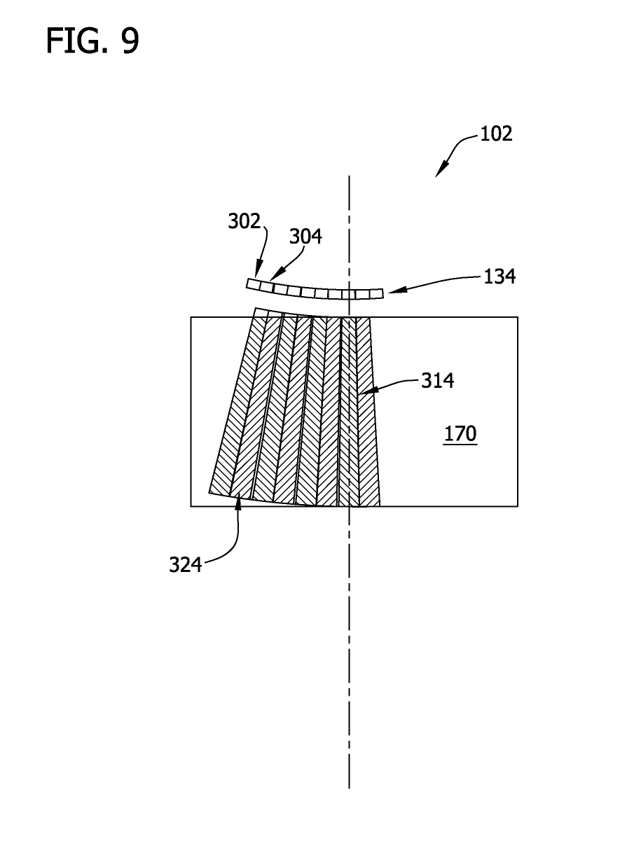

FIGS. 8 and 9 are schematic cross-sectional views of a portion of fan-beam XDI device 102. Coordinate system 103, including x-axis 105, y-axis 107, and z-axis 109 are shown for consistent perspective. Primary collimator 134 includes first row of primary aperture slits 220 and second row 230. A portion 302 of first row 220 includes four slits 222 and a portion 304 of second row 230 of slits 222 are used to show the relationship between first row 220 and second row 230 and the x-ray radiation associated therewith. As described above, primary collimator 134 has a concave shape facing radiation source 130 and a convex shape facing object space 170. Alternatively, primary collimator 134 has a substantially flat configuration and the orientation and spacing of slits 222 and rows 220 and 230 are adjusted accordingly for example, without limitation, defining a length of each of slits 222 with a unique length in the direction of y-axis 107.

In the exemplary embodiment, portion 302 is aligned with a first, or a z⁺ portion 306 of x-ray stream 132, such z⁺ portion 306 aligned with first (z⁺) x-y plane 244. Detector array 160 and detector channels 162 thereof define a plurality of z⁺ detector beam volumes 308 that are similar to detector beam volumes 186 and 196 (both shown in FIG. 3). Secondary collimator 150 and horizontal apertures 154 thereof define a plurality of z⁺ secondary collimator detection volumes 310 that are similar to first and second secondary collimator detection volumes 180 and 190, respectively (both shown in FIG. 3). Portion 302 is positioned between radiation source 130 and secondary collimator 150 and defines a plurality of z⁺ x-ray fan-beams 312 from z⁺ portion 306 of x-ray stream 132. z⁺ x-ray fan-beams 312 are shown as diverging from radiation source 130 to clearly show radiation source 130 as the focal point of radiation in XDI device 102. z⁺ x-ray fan-beams 312 intersect associated z⁺ secondary collimator detection volumes 310 to define a plurality of z⁺ irradiated volumes 314 that are similar to first and second irradiated volumes 184 and 194, respectively (both shown in FIG. 3). Those portions of objects (not shown) positioned in object space 170 that are irradiated within z⁺ irradiated volumes 314 facilitate scattering x-rays (not shown) of associated z⁺ x-ray fan-beams 312 in associated z⁺ secondary collimator detection volumes 310 at a predetermined scatter angle Θ (not shown in FIG. 8) for channeling into associated detector channels 162 via associated z⁺ detector beam volumes 308.

In the exemplary embodiment, each of apertures 154 are sized and oriented to define each associated z⁺ secondary collimator detection volumes 310 such that a width of detection volumes 310 at primary collimator 134 is P_{b}+2*Pₐ (both also shown in FIG. 5 and defined above), detection volumes 312 are substantially centered about associated primary aperture slit 222, and no portions of adjacent primary aperture slits 222 are included therein. There is some overlap of adjacent detection volumes 312 at, or near, primary collimator 134 along y-axis 107 in the x-z plane. However, there is substantially no overlap of z⁺ irradiated volumes 314 and associated portions of adjacent detection volumes 312.

Therefore, in the exemplary embodiment, a particular detector channel 162 may not receive all x-rays scattered within an associated detection volume 310, however, a scattered x-ray in a particular z⁺ irradiated volume 314 within associated detection volume 310 will most likely only enter associated detector channel 162, thereby facilitating image resolution by XDI device 102.

Also, in the exemplary embodiment, portion 304 is aligned with a second, or a z⁻ portion 316 of x-ray stream 132, such z⁻ portion 316 aligned with second (z) x-y plane 246. FIG. 8 shows the shift of portion 304 with respect to portion 302 in the direction of y-axis 107. Detector array 160 and detector channels 162 thereof define a plurality of z⁻ detector beam volumes 318 that are similar to detector beam volumes 308. Secondary collimator 150 and horizontal apertures 154 thereof define a plurality of z⁻ secondary collimator detection volumes 320 that are similar to secondary collimator detection volumes 310. Portion 304 is positioned between radiation source 130 and secondary collimator 150 and defines a plurality of z⁻ x-ray fan-beams 322 from z⁻ portion 316 of x-ray stream 132. z⁻ x-ray fan-beams 322 are shown as converging on, or diverging from, radiation source 130 to clearly show radiation source 130 as the focal point of radiation in XDI device 102. z⁻ x-ray fan-beams 322 intersect associated z⁻ secondary collimator detection volumes 320 to define a plurality of z⁻ irradiated volumes 324 that are similar to irradiated volumes 314. Those portions of objects (not shown) positioned in object space 170 that are irradiated within z⁻ irradiated volumes 324 facilitate scattering x-rays (not shown) of associated z⁻ x-ray fan-beams 322 in associated z⁻ secondary collimator detection volumes 320 at a predetermined scatter angle Θ for channeling into associated detector channels 162 via associated z⁻ detector beam volumes 318.

In the exemplary embodiment, each of apertures 154 are sized and oriented to define each associated z⁻ secondary collimator detection volumes 320 such that a width of detection volumes 320 at primary collimator 134 is P_{b}+2*Pₐ, detection volumes 322 are substantially centered about associated primary aperture slit 222, and no portions of adjacent primary aperture slits 222 are included therein. There is some overlap of adjacent detection volumes 322 at, or near, primary collimator 134 along y-axis 107 in the x-z plane. However, there is substantially no overlap of z⁻ irradiated volumes 324 and associated portions of adjacent detection volumes 322 along y-axis 107 in the x-z plane. Therefore, a probability of scattering x-rays into an undesired detection volume is significantly reduced.

Also, in the exemplary embodiment, and as described above, angle α is a function of row separation distance P_{z} and distance D₁ between primary collimator 134 and radiation source 130 and sizing and orientation of secondary collimator 150. Planes 244 and 246 are substantially parallel with distance P_{z} defined therebetween, thereby defining a masked dual fan-beam (MDFB) configuration. That is, rows 220 and 230 of primary collimator 134 facilitate masking adjacent irradiated volumes 314 and 324 from each other such that adjacent irradiated volumes 314 and 324 have substantially no overlap, while substantially all of object space 170 is irradiated.

Therefore, in the exemplary embodiment, a particular detector channel 162 may not receive all x-rays scattered within an associated detection volume 320, however, a scattered x-ray in a particular z⁻ irradiated volume 324 within associated detection volume 320 will most likely only enter associated detector channel 162, thereby facilitating image resolution by XDI device 102.

FIG. 9 shows z⁺ irradiated volumes 314 and z⁻ irradiated volumes 324 such that substantially 100% of an object (not shown) in each x-y plane along z-axis 109 in object space 170 is irradiated and scattered x-rays from each of a particular z⁺ secondary collimator detection volume 310 and a particular z⁻ secondary collimator detection volume 320 are detected. Radiation source 130 irradiates both volumes 314 and 324 simultaneously, therefore, a significant portion of the object is irradiated, thereby facilitating a reduction in scan time and a reduction in reversal of travelling belt 110 and facilitating an increase in object throughput and an efficiency and effectiveness of the scanning activities.

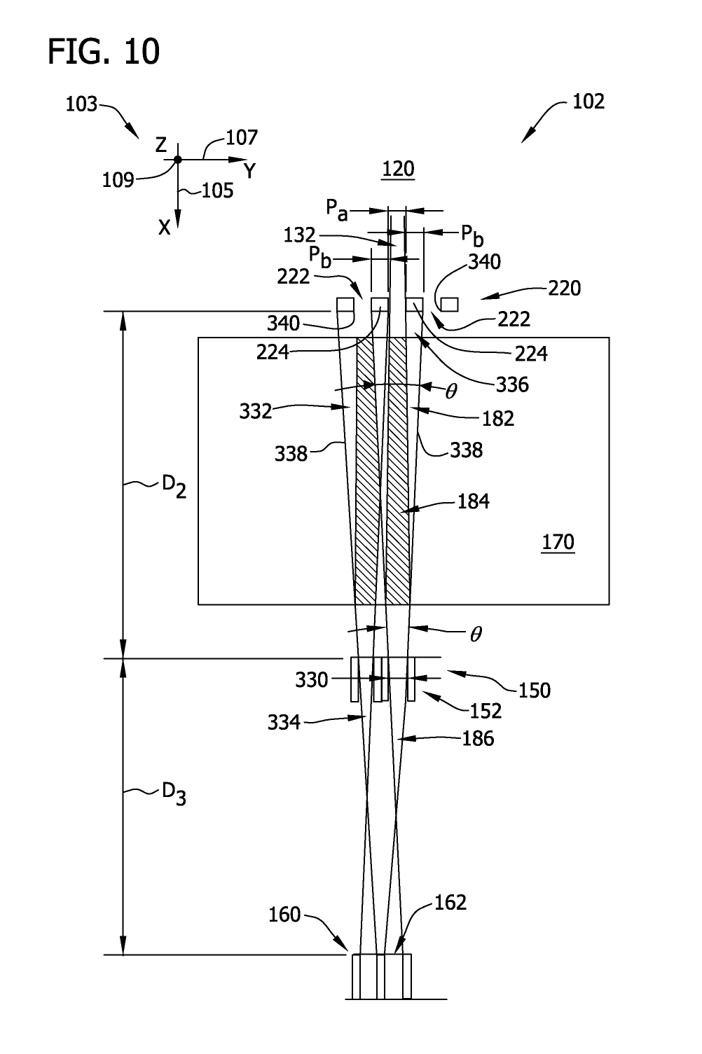

FIG. 10 is a schematic cross-sectional view of a portion of fan-beam XDI device 102. Coordinate system 103, including x-axis 105, y-axis 107, and z-axis 109 are shown for consistent perspective. As described above for FIG. 2, each of apertures 152 defines an opening angle θ that extends in the direction of y-axis 107 in the x-y plane. Aperture opening angle θ is predetermined and defined in the MDFB configuration by second distance D₂ and third distance D₃ in the direction of x-axis 105, and primary aperture slits spacing Pₐ plus twice primary aperture slits length P_{b}, i.e., Pₐ+2 P_{b} in the direction of y-axis 107, and a secondary collimator aperture slit width 330 in the direction of y-axis 107. Predetermined values of aperture opening angle θ facilitate sizing and orienting first secondary collimator detection volume 180 such that secondary collimator detection volume 180 defines a small, non-interfering intersecting volume with any adjacent secondary collimator detection volumes 332 (only one shown in FIG. 10) (as discussed further below). Also, predetermined values of aperture opening angle θ facilitate sizing and orienting first detector beam volume 186 such that detector beam volume 186 does not intersect any adjacent detector beam volumes 334 (only one shown in FIG. 10).

In general, secondary collimator detection volumes are substantially quadrilateral in shape such that a portion of the volume in the vicinity of a primary collimator is relatively wider than a portion of the volume in the vicinity of the secondary collimator. In order to eliminate a potential for overlap of the secondary collimator detection volumes, the sizing of the portion of the volume in the vicinity of the primary collimator is limited in size. Therefore, limiting a value of aperture opening angle θ to reduce an intersection of adjacent secondary collimator detection volumes and adjacent detector beam volumes also necessarily limits values of such secondary collimator detection volumes. However, such limiting of secondary collimator detection volumes to reduce overlapping of adjacent secondary collimator detection volumes defines gaps in coverage of object space 170 by the plurality of secondary collimator detection volumes. Such gaps will reduce the efficiency and effectiveness of a fan-beam XDI device in fully scanning an object positioned in object space 170.

In the exemplary embodiment, primary aperture slits 222 in each of rows 220 and 230 (shown in FIGS. 5, 6, 7, and 8) are separated by material 224 in the direction of y-axis 107. Material 224 defines a non-irradiated, i.e., shaded volume 336 associated with secondary collimator detection volume 180 adjacent to irradiated volume 184, both associated with vertical aperture 182 of secondary collimator 150. Such shaded volume 336 receives no portion of primary x-ray fan-beam 120 and facilitates widening of aperture opening angle θ to define at least some overlap of secondary collimator detection volumes 180 in shaded volumes 336. Edges 338 of secondary collimator detection volumes 180 are spread in the direction of y-axis 107 with increasing aperture opening angle θ in the x-y plane to intersect edges 340 of material 224. Therefore, widening of aperture opening angle θ in the x-y plane is limited to a value defined by primary aperture slits spacing Pₐ plus twice primary aperture slits length P_{b}, i.e., Pₐ+2 P_{b} in the direction of y-axis 107. In the exemplary embodiment, spacing Pₐ is substantially congruent to length P_{b}. Adjacent shaded volumes 336 overlap with substantially no deleterious effect on eliminating scattered x-rays from adjacent volumes while increasing a portion of object space 170 that is covered by secondary collimator detection volumes 180. In the exemplary embodiment, detection gaps in object space 170 are decreased and an efficiency and effectiveness of XDI device 102 is increased.

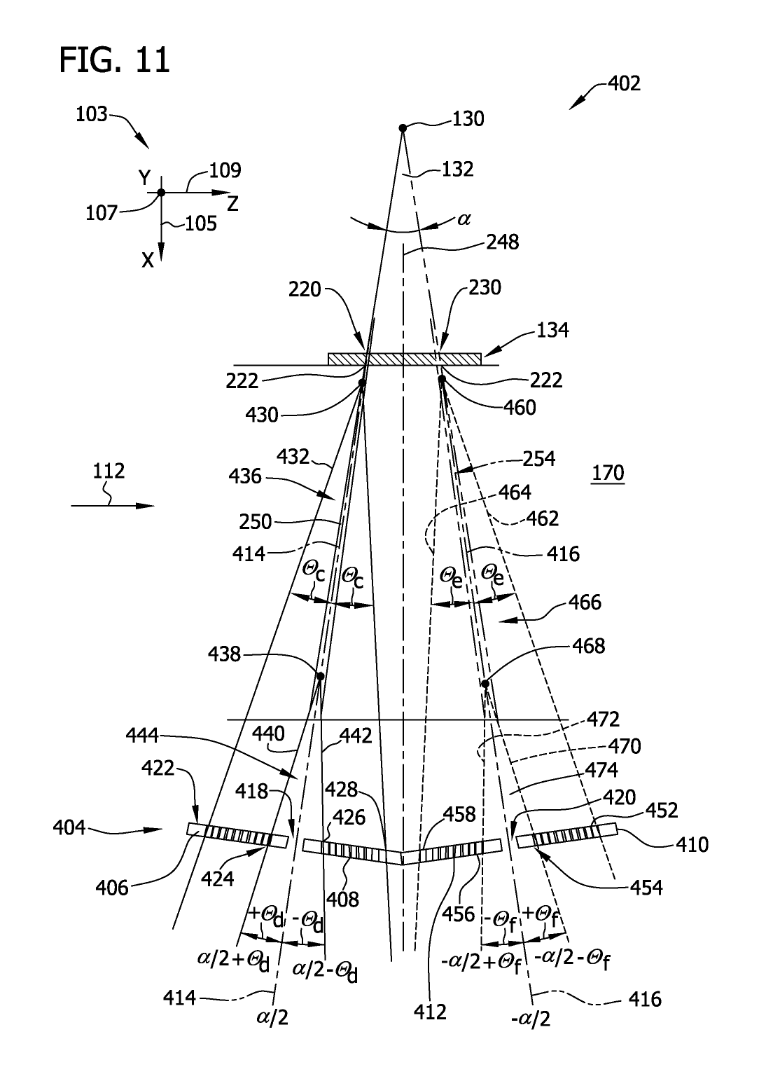

FIG. 11 is a schematic cross-sectional view of a portion of an alternative fan-beam XDI device 402 that may be used with security system 101 (shown in FIG. 1). Coordinate system 103, including x-axis 105, y-axis 107, and z-axis 109 are shown for consistent perspective. Primary collimator 134 has a concave shape facing radiation source 130 and a convex shape facing object space 170. However, for illustrative purposes, primary collimator 134 is shown in a substantially flat configuration. In this alternative exemplary embodiment, an alternative secondary collimator 404 is positioned between primary collimator 134 and detector array 160 (shown in FIGS. 2, 4, 8, and 10). Secondary collimator 404 includes a first portion 406, a first extension 408, a second portion 410, and a second extension 412. Second portion 410 and second extension 412 are shifted a distance of approximately spacing Pₐ in the direction of y-axis 107 and are shown in phantom. XDI device centerline 248 defines a symmetrical relationship between first portion 406 and first extension 408, and second portion 410 and second extension 412, respectively. Also, XDI device centerline 248 defines a first angle with a value of α/2 with respect to centerline 248 and a first straight line 414 defined by radiation source 130 and first row of primary aperture slits 220. First x-ray slit-beam 250 is defined along first straight line 414. Further, first straight line 414 defines a separation 418 between first portion 406 and first extension 408. In this alternative exemplary embodiment, separation 418 is large enough to physically separate first portion 406 and first extension 408 and to facilitate channeling scattered x-rays to detector array 160.

Similarly, XDI device centerline 248 defines a second angle with a value of −α/2 with respect to centerline 248 and a second straight line 416 defined by radiation source 130 and second row of primary aperture slits 230. Second x-ray slit-beam 254 is defined along second straight line 416. Second straight line 416 defines a separation 420 between second portion 410 and second extension 412. In this alternative exemplary embodiment, separation 420 is large enough to physically separate second portion 410 and second extension 412 and to facilitate channeling scattered x-rays to detector array 160.

First portion 406 of secondary collimator 404 includes a first vertical aperture 422 and a last vertical aperture 424. Similarly, first extension 408 also includes a first vertical aperture 426 and a last vertical aperture 428. A first upper scattering point 430 just downstream of slit 222 of first row 220, first vertical aperture 422, and first straight line 414 define a scattering angle Θ_{c} and a first scatter ray 432. An x-ray scattered at an angle greater than scattering angle Θ_{c} will not be channeled toward detector array 160 by secondary collimator 404. First upper scattering point 430, last vertical aperture 428, and second straight line 416 define a substantially symmetrical scattering angle −Θ_{c} and a last scatter ray 434. An x-ray scattered at an angle greater than scattering angle −Θ_{c} will not be channeled toward detector array 160 by secondary collimator 404. Therefore, scattering angle Θ_{c} and scattering angle −Θ_{c} define a first secondary collimator detection volume 436 bounded by first scatter ray 432 and last scatter ray 434.

Last vertical aperture 424, first straight line 414, and a first bottom scattering point 438 within first secondary collimator detection volume 436 just upstream of a bottom of object space 170 define a scattering angle Θ_{d} and a first bottom scatter ray 440. First bottom scattering point 438, first vertical aperture 426, and first straight line 414 define a substantially symmetrical scattering angle −Θ_{d} and a last bottom scatter ray 442. Therefore, scattering angle Θ_{d} and scattering angle −Θ_{d} define a bottom secondary collimator detection volume 444 bounded by first bottom scatter ray 440 and last bottom scatter ray 442.

In this alternative exemplary embodiment, Θ_{c} is substantially congruent to Θ_{d} and first scatter ray 432 is substantially parallel to first bottom scatter ray 440. Similarly, −Θ_{c} is substantially congruent to −Θ_{d} and last scatter ray 434 is substantially parallel to last bottom scatter ray 442. Also, in this alternative exemplary embodiment, XDI device 402 defines a masked dual fan-beam (MDFB) configuration that includes any number of vertical aperture between first vertical aperture 422 and last vertical aperture 424, and any number of vertical aperture between first vertical aperture 426 and last vertical aperture 428 that enables operation of XDI device 402 and security system 101 as described herein. Further, XDI device 402 defines any number of secondary collimator detectable volumes (not shown in FIG. 11) and irradiated volumes (not shown in FIG. 11) associated with first portion 406 and first extension 408 of secondary collimator 404 that enables operation of XDI device 402 and security system 101 as described herein. In this alternative exemplary embodiment, each of such secondary collimator detectable volumes includes an intersection with first x-ray slit-beam 250 to define the associated irradiated volumes such that a scattered x-ray detected in detection array 160 will be channeled from a particular vertical aperture from a particular secondary collimator detectable volume with substantially no probability that the scattered x-ray originated from an adjacent secondary collimator detectable volume.

In general, the greater the number of vertical aperture, the greater the number of scattering angles Θ, since each vertical aperture defines a different scattering angle Θ with an x-ray slit-beam. Bragg's Law defines a relationship between scattering angle Θ and an energy of the scattered x-rays:

E=K/[2*d*sin(|Θ|)], or Eq. (1)

N*λ=2*d*sin(|Θ|), Eq. (2)

wherein E is the energy of the scattered x-ray. K is a constant, d is the spacing between planes in an atomic lattice of the material, Θ is the scattering angle of the x-ray, |Θ| is the absolute value of the scattering angle, N is a constant integer, and λ is the wavelength of the scattered x-ray. The broader the energy spectrum detected and the greater the granularity of the spectrum, the more efficient and effective is the operation of the associated security system. The results of the equation will be the same regardless if Θ is positive or negative.

For example, without limitation, an energy spectrum of fixed-angle scatter at a small angle Θ of approximately 0.04 radians from an object irradiated by polychromatic x-rays of energy between 40 kiloelectron-volts (keV) and 140 keV can be directly converted into an x-ray diffraction (XRD) profile by computer processing system 108. In a similar manner, an energy spectrum of fixed-angle scatter at a small angle Θ of approximately 0.02 radians from an object irradiated by polychromatic x-rays of energy between 80 keV and 240 keV can be directly converted into an XRD profile. Also, in a similar manner, an energy spectrum of fixed-angle scatter at a small angle Θ of approximately 0.01 radians from an object irradiated by polychromatic x-rays of energy between 30 keV and 100 keV can be directly converted into an XRD profile. Therefore, the energy spectrum of the scattered x-rays is inversely proportional to the scatter angle.

XDI device centerline 248 defines a substantially symmetrical “mirror-image” of XDI device 402 in the direction of z-axis 109 in the x-y plane. Second portion 410 and second extension 412, and all of the associated vertical apertures, scattering points, scattering angles, scatter rays, and detection volumes, all as discussed further below, are shifted a distance of approximately spacing Pₐ in the direction of y-axis 107 and are shown in phantom.

Second portion 410 of secondary collimator 404 includes a first vertical aperture 452 and a last vertical aperture 454. Similarly, second extension 412 also includes a first vertical aperture 456 and a last vertical aperture 458. A second upper scattering point 460 just downstream of slit 222 of second row 230, first vertical aperture 452, and second straight line 416 define a scattering angle Θₑ and a first scatter ray 462. An x-ray scattered at an angle greater than scattering angle Θₑ will not be channeled toward detector array 160 by secondary collimator 404. Second upper scattering point 460, last vertical aperture 458, and second straight line 416 define a substantially symmetrical scattering angle −Θₑ and a last scatter ray 464. An x-ray scattered at an angle greater than scattering angle −Θₑ will not be channeled toward detector array 160 by secondary collimator 404. Therefore, scattering angle Θₑ and scattering angle −Θₑ define a second secondary collimator detection volume 466 bounded by first scatter ray 462 and last scatter ray 464.

Last vertical aperture 454, second straight line 416, and a second bottom scattering point 468 within second secondary collimator detection volume 466 just upstream of the bottom of object space 170 define a scattering angle Θ_{f} and a first bottom scatter ray 470. First bottom scattering point 468, first vertical aperture 456, and second straight line 416 define a substantially symmetrical scattering angle −Θ_{f} and a last bottom scatter ray 472. Therefore, scattering angle Θ_{f} and scattering angle −Θ_{f} define a bottom secondary collimator detection volume 474 bounded by first bottom scatter ray 470 and last bottom scatter ray 472.

In this alternative exemplary embodiment, scatter angle Θₑ is substantially congruent to scatter angle Θ_{f} and first scatter ray 462 is substantially parallel to first bottom scatter ray 470. Similarly, scatter angle −Θₑ is substantially congruent to scatter angle −Θ_{f} and last scatter ray 464 is substantially parallel to last bottom scatter ray 472.

Also, in this alternative exemplary embodiment, XDI device 402 defines a masked dual fan-beam (MDFB) configuration that includes any number of vertical apertures between first vertical aperture 452 and last vertical aperture 454, and any number of vertical aperture between first vertical aperture 456 and last vertical aperture 458 that enables operation of XDI device 402 and security system 101 as described herein. Further, XDI device 402 defines any number of secondary collimator detectable volumes (not shown in FIG. 11) and irradiated volumes (not shown in FIG. 11) associated with second portion 410 and second extension 412 of secondary collimator 404 that enables operation of XDI device 402 and security system 101 as described herein. In this alternative exemplary embodiment, each of such secondary collimator detectable volumes includes an intersection with second x-ray slit-beam 254 to define the associated irradiated volumes such that a scattered x-ray detected in detection array 160 will be channeled from a particular vertical aperture from a particular secondary collimator detectable volume with substantially no probability that the scattered x-ray originated from an adjacent secondary collimator detectable volume.

In general, the symmetrical characteristics of XDI device 402 along z-axis 109 in conjunction with the alternating shift of slits 222 along y-axis 107 facilitates irradiating a significant percentage of object space 170 and objects (not shown in FIG. 11) therein. Also, in general, the greater the number of scattering angles Θ as described above facilitates a broader energy spectrum of detected x-rays with the subsequent greater granularity of the spectrum, as defined by Eq. (1) and (2) above. Further, in general, greater numbers of scattered x-rays facilitates greater statistical certainty of results associated with x-ray detection, thereby facilitating more efficient and effective operation of the associated security system. Moreover, in general, extensions 408 and 412 facilitate detection of scattered x-rays between first portion 406 and second portion 410 of secondary collimator 404, thereby further facilitating more efficient and effective operation of the associated security system.

In some embodiments, additional extensions along z-axis 109 positioned symmetrically about centerline 248 also further facilitate more efficient and effective operation of the associated security system as long as fan spread angle α is equal to or greater than the scattering angles Θ. Also, by increasing a number of detectors and secondary collimator portions, an efficiency of the associated security system can nearly be proportionally increased by keeping the radiation power constant. Further, the radiation power may be decreased while maintaining the previous efficiency.

The above-described method and fan-beam x-ray diffraction imaging (XDI) devices described herein facilitate effective and efficient operation of security systems. The security systems include an effective fan-beam XDI device that significantly decreases mechanical movements of XDI device components, thereby facilitating a reduction of capital, maintenance and operational costs associated with ownership of such security system. Also, the security systems include a fan-beam XDI device that includes a multi-plane primary collimator and a multi-plane secondary collimator, both facilitating substantial parallel imaging and analysis of items under scrutiny, thereby providing the user of the security system described herein with a reduction in the scanning time of each item being scrutinized. Further, the method and imaging device disclosed herein results in increasing the signal of legitimate scattered x-rays while decreasing the number of cross-talk x-rays, thereby increasing the detection rate and decreasing a number of false alarms associated with contraband substances and materials. Moreover, the fan-beam XDI device described herein has a sufficiently small footprint to facilitate inclusion within many existing security checkpoints. Furthermore, the security systems include a fan-beam XDI device that facilitates analysis within a broader energy spectrum of detected x-rays and with a greater granularity of the spectrum.

Exemplary embodiments of methods and fan-beam XDI devices for operating a security system are described above in detail. The methods and fan-beam XDI devices are not limited to the specific embodiments described herein, but rather, components of systems and/or steps of the methods may be utilized independently and separately from other components and/or steps described herein. For example, the methods may also be used in combination with other security systems and methods, and are not limited to practice with only the security systems as described herein. Rather, the exemplary embodiment can be implemented and utilized in connection with many other security system applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An x-ray diffraction imaging (XDI) device comprising:
at least one x-ray source configured to emit an x-ray fan-beam; and
a primary collimator positioned downstream of said at least one x-ray source, said primary collimator defining a plurality of rows of slits, each slit and each row of slits separated by an x-ray absorbing material, each of said rows of slits oriented to transmit at least one x-ray slit-beam in a plane substantially orthogonal to said primary collimator.

2. An XDI device in accordance with claim 1, wherein each of said rows of slits is configured to transmit a plurality of x-ray slit-beams, each x-ray slit-beam configured to not intersect with adjacent x-ray slit-beams.

3. An XDI device in accordance with claim 1, wherein said x-ray absorbing material masks portions of the x-ray fan-beam from an object space downstream of said primary collimator.

4. An XDI device in accordance with claim 1 further comprising a secondary collimator, said secondary collimator and said primary collimator define an object space therebetween, said secondary collimator comprises a plurality of apertures sized and oriented to define a plurality of detection volumes within the object space, wherein each of said detection volumes extends from an aperture defined within said secondary collimator to said primary collimator.

5. An XDI device in accordance with claim 4, wherein each of said detection volumes intersects one of said x-ray slit-beams, thereby defining an irradiated volume.

6. An XDI device in accordance with claim 5, wherein each of said detection volumes is substantially quadrilateral in shape and is sized and oriented such that:
at least a portion of at least one of said detection volumes intersects at least a portion of an adjacent detection volume upstream of the irradiated volume; and
each of said detection volumes is substantially non-intersecting with adjacent detection volumes downstream of the irradiated volume.

7. An XDI device in accordance with claim 5, wherein each of said irradiated volumes is substantially non-intersecting with adjacent irradiated volumes.

8. An XDI device in accordance with claim 4, wherein each secondary collimator aperture is oriented to receive scattered x-rays from only one predetermined detection volume.

9. An XDI device in accordance with claim 4, wherein said secondary collimator apertures are sized and oriented to receive x-rays scattered with a predetermined range of scattering angles defined within a predetermined detection volume.

10. An XDI device in accordance with claim 1 further comprising at least one detector array, wherein said at least one detector array defines a plurality of detector channels, wherein each of said detector channels is sized and oriented to receive x-rays scattered from a predetermined detection volume.

11. An x-ray diffraction imaging (XDI) device, said device comprising:
a primary collimator comprising an x-ray absorbing material defining a plurality of slits therein, said plurality of slits defines at least one row of slits extending in a first dimension in a first plane; and
a secondary collimator positioned downstream of said primary collimator, said secondary collimator defines an aperture that defines a substantially quadrilateral detection volume that defines a plurality of detection volume edges and an aperture opening angle therebetween such that each of said plurality of detection volume edges intersects a portion of said x-ray absorbing material, said x-ray absorbing material at least partially defines adjacent slits in said at least one row of slits.

12. An XDI device in accordance with claim 11, wherein said at least one row of slits defined in said primary collimator comprises a plurality of rows of slits, wherein:
each of said slits in each of said rows is separated by said x-ray absorbing material in the first dimension, thereby defining a spacing therebetween;
each of said plurality of rows of slits separated by said x-ray absorbing material in a second dimension in a second plane that is substantially orthogonal to the first plane, thereby defining a separation distance therebetween; and
each slit has a length extending in the first dimension.

13. An XDI device in accordance with claim 12, wherein:
the slit length and the slit spacing are substantially congruent; and
wherein each row of slits comprises substantially similar slits with substantially similar slit lengths with substantially similar spacings therebetween.

14. An XDI device in accordance with claim 13, wherein said plurality of detection volume edges and said aperture opening angle therebetween are defined such that each of said plurality of detection volume edges intersects said portion of said x-ray absorbing material to define a length in the first dimension that is substantially equivalent to a summation of a slit length and two slit spacings.

15. An XDI device in accordance with claim 14, wherein said plurality of rows of slits comprises a first row of slits and a second row of slits defining said separation distance therebetween, said first row of slits defines a first x-ray slit-beam substantially orthogonal to said primary collimator and said second row of slits defines a second x-ray slit-beam substantially orthogonal to said primary collimator.

16. An XDI device in accordance with claim 15, wherein said secondary collimator defines a plurality of substantially quadrilateral detection volumes extending through the second plane that intersect at least a portion of at least one of said first x-ray slit-beam and said second x-ray slit-beam, thereby defining a plurality of irradiated volumes extending through the second plane.

17. An XDI device in accordance with claim 16 further comprising an x-ray source configured to emit an x-ray fan-beam that defines a spread angle that is at least partially defined by at least one of:
said separation distance between said first row of slits and said second row of slits in the second plane and a distance between said x-ray source and said primary collimator; and
said plurality of irradiated volumes extending through the second plane.

18. An object imaging system, said system comprising:
at least one computer processor;
a traveling belt; and
an x-ray diffraction imaging (XDI) device coupled to said at least one computer processor, said XDI device comprising:
at least one x-ray source configured to emit an x-ray fan-beam;
a primary collimator positioned downstream of said at least one x-ray source, said primary collimator defining a plurality of rows of slits, each slit and each row of slits separated by an x-ray absorbing material, each of said rows of slits oriented to transmit at least one x-ray slit-beam; and
a secondary collimator positioned downstream of said primary collimator, wherein said primary collimator and said secondary collimator define an object space therebetween, at least a portion of said travelling belt extends through said object space, and said x-ray absorbing material masks portions of the x-ray fan-beam emitted from said x-ray source from said object space.

19. An object imaging system in accordance with claim 18, wherein each of said rows of slits is configured to transmit a plurality of x-ray slit-beams, each x-ray slit-beam configured to not intersect with adjacent x-ray slit-beams.

20. An object imaging system in accordance with claim 19, wherein said secondary collimator comprises a plurality of apertures sized and oriented to define a plurality of detection volumes within the object space and each of said detection volumes intersects one of said x-ray slit-beams, thereby defining a plurality of irradiated volumes, and wherein each of said irradiated volumes is substantially non-intersecting with adjacent irradiated volumes, said detection volumes are sized and oriented to be substantially non-intersecting with adjacent irradiated volumes, wherein each secondary collimator aperture is oriented to receive scattered x-rays from only one predetermined detection volume.
